(19) United States
(12) Patent Application Publication
(10) Pub. No.: US 2025/0265681 A1
(43) Pub. Date: Aug. 21, 2025

(54) DIGITAL NIGHT VISION DEVICE USING ARTIFICIAL-INTELLIGENCE BASED IMAGE SIGNAL PROCESSING

(71) Applicant: DeepNight Inc., San Francisco, CA (US)

(72) Inventors: Lucas D. Young, Oakland, CA (US); Thomas H. Li, San Francisco, CA (US); Sukrit Arora, San Francisco, CA (US); Shruthi Santhanam, San Francisco, CA (US); Qilin Zhang, Menlo Park, CA (US); Anurag Ranjan, San Francisco, CA (US)

(21) Appl. No.: 18/983,296

(22) Filed: Dec. 16, 2024

Related U.S. Application Data
(60) Provisional application No. 63/555,999, filed on Feb. 21, 2024.

(51) Int. Cl. G06T 5/60; G06F 3/01; G06T 5/50; G06T 5/70; G06T 7/33

(52) U.S. Cl. CPC G06T 5/60; G06T 5/50; G06T 5/70; G06T 7/337; G06F 3/013; G06T 2200/28; G06T 2207/20081; G06T 2207/20084; G06T 2207/20221

(57) ABSTRACT

A digital night vision device uses a night vision model to enhance video data of a scene. The device includes a sensor assembly and a neural processing unit (NPU). The sensor assembly captures RAW video data of a scene. The RAW video data includes a RAW image frame and an immediately prior RAW image frame. The NPU aligns an encoded version of the RAW image frame with an encoded version of the immediately prior RAW image frame to form an aligned encoded image frame. The NPU applies at least a portion of the aligned encoded image frame and a latent frame history to a night vision model to generate an enhanced image frame of the scene. Enhanced video data of the scene may be presented using a display. The enhanced video data is based in part on a plurality of enhanced image frames including the enhanced image frame.

### CROSS-REFERENCE TO RELATED APPLICATIONS

This application claims the benefit of U.S. Provisional Application No. 63/555,999, filed Feb. 21, 2024, which is incorporated by reference in its entirety.

### FIELD OF THE INVENTION

The disclosure relates generally to night vision devices, and more specifically to a digital night vision device that uses artificial intelligence based image signal processing.

### BACKGROUND

Night vision devices provide their users with enhanced situational awareness and mission effectiveness during nocturnal operations. Conventional night vision devices utilize the image intensifier tube, an analog technology that converts photons to electrons, amplifies the electrons, and converts the electrons back to photons to render an enlightened image. The drawback of conventional night vision is that the photons are not converted to a digital signal at any point, which precludes its adaptability to many applications. Moreover, wide angle lenses are additionally not used for conventional night vision devices due to the expensive manufacturing process of custom optics.

Digital night vision devices utilize cameras with a sensor that is optimized for extreme low light. The digital image from the sensor is processed with an image signal processor (ISP), which renders a night vision image. However, the magnitude of enlightenment provided by these low light sensors is far inferior to that of conventional night vision. Furthermore, wide angle lenses are usually not chosen due to the greater perspective distortion. Being limited to narrow lenses further limits the situational awareness of the user.

### SUMMARY

In accordance with one or more aspects of the disclosure, a digital night vision device that uses artificial intelligence based image signal processing is described. The digital night vision device may use a night vision model to enhance video data of an imaged scene (e.g., low light scene). The digital night vision device may include a sensor assembly and a neural processing unit (NPU). The sensor assembly may be configured to capture RAW video data of a scene. The RAW video data includes a RAW image frame and an immediately prior RAW image frame. The NPU may align an encoded version of the RAW image frame with an encoded version of the immediately prior RAW image frame to form an aligned encoded image frame. The NPU may apply at least a portion of the aligned encoded image frame and a latent frame history to the night vision model to generate an enhanced image frame of the scene. Enhanced video data of the scene may be presented using a display of a display assembly. The enhanced video data is based in part on a plurality of enhanced image frames including the enhanced image frame.

In some embodiments the digital night vision device may be part of a head-mounted night vision system. For example, the head-mounted night vision system may include a sensor assembly, a NPU, and a display assembly. The sensor assembly may be configured to capture RAW video data of a scene, The RAW video data may include a RAW image frame and an immediately prior RAW image frame. The NPU may be configured to align an encoded version of the RAW image frame with an encoded version of the immediately prior RAW image frame to form an aligned encoded image frame. The NPU may be configured to apply at least a portion of the aligned encoded image frame and a latent frame history to a night vision model to generate an enhanced image frame of the scene. The display assembly may include a display that is configured to present enhanced video data of the scene based that is based in part on a plurality of enhanced image frames including the enhanced image frame.

In some embodiments, a method is described to form a night vision model. Low noise video data is processed to generate training image pairs. Each training image pair includes a low noise image frame and a noisy image frame that was generated in part using the low noise image frame. A foundation model is trained using the training image pairs. The foundation model is distilled to form a small model. Quantization is performed on the small model, and quantization aware training is performed on the small model to form the night vision model.

### BRIEF DESCRIPTION OF THE DRAWINGS

FIG. 1A illustrates a digital night vision device capturing video data of a scene, according to one or more embodiments.

FIG. 1B illustrates an example RAW image frame of the video data captured by the digital night vision device of FIG. 1A.

FIG. 1C illustrates an example enhanced image frame that is generated from the RAW image frame of FIG. 1B.

FIG. 2 is a block diagram of a digital night vision device, in accordance with one or more embodiments.

FIG. 3A is a flowchart for a method of forming a night vision model, in accordance with some embodiments.

FIG. 3B is a flowchart for a method of generating training image pairs using low noise video data, in accordance with some embodiments.

FIG. 4 is a block diagram of a process for distilling a foundation model to form a small model, in accordance with some embodiments.

FIG. 5 is a flowchart for a method of using a digital night vision device to generate enhanced video data of a scene, in accordance with some embodiments.

FIG. 6A is a perspective view of an example head-mounted night vision system, in accordance with one or more embodiments.

FIG. 6B is a cross sectional view of a digital night vision device of FIG. 6A.

FIG. 7 is a block diagram of a process of operation of a night vision model having multiple networks, in accordance with some embodiments.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

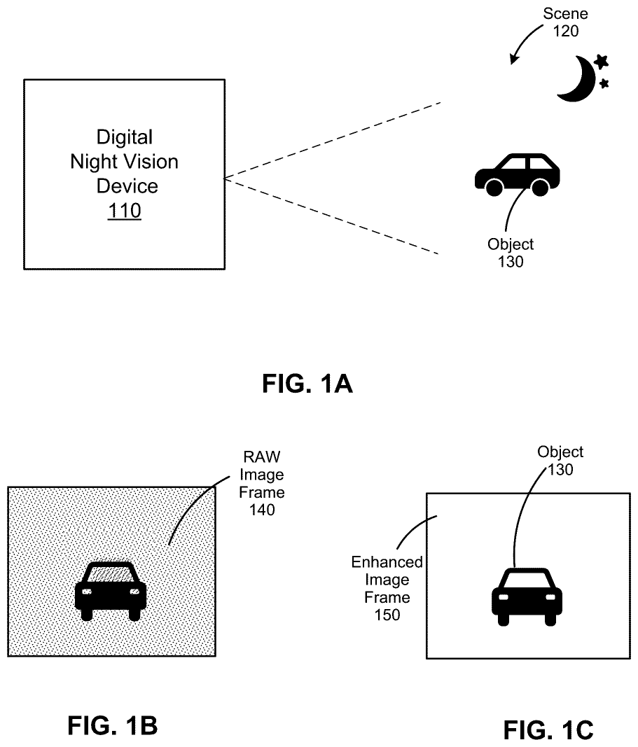

FIG. 1A illustrates a digital night vision device 110 capturing video data of a scene 120, according to one or more embodiments. The scene 120 may have low light (e.g., 0.1 milli-Lux or lower) and include one or more poorly illuminated objects (e.g., an object 130). For example, the scene 120 may be of the object 130 at night, in a dark building, etc. Note in other embodiments, the scene 120 may have a higher Lux level. The digital night vision device 110 includes a sensor assembly and a System on a Chip (SoC) that includes a neural processor unit (NPU). The sensor assembly includes one or more sensors (e.g., low light sensors) that are configured to image the scene 120. The SoC receives RAW video data from the sensor assembly. The raw video data comprises uncompressed data from the sensor assembly that is extracted prior to being processed. Instead of processing the RAW video data with a hardware image signal processor (ISP), the SoC processes the RAW video data with a night vision model that runs on the NPU. The night vision model is a recurrent neural network. In this manner, the digital night vision device 110 applies the captured video data to the night vision model to generate corresponding enhanced video. In some embodiments, the enhanced video may be warped with a real-time perspective correction prior to presentation to a user of the digital night vision device 110.

FIG. 1B illustrates an example RAW image frame 140 of the video data captured by the digital night vision device 110 of FIG. 1A. Note that as the scene 120 is low light, the RAW image frame 140 is dark and objects in the scene 120 are not clearly visible. Moreover, due to the lighting conditions, the RAW image frame 140 includes a large percentage of noise relative to signal. As such, simply brightening the RAW image frame 140 would also greatly increase the noise, resulting is a very poor quality enlightened image frame.

FIG. 1C illustrates an example enhanced image frame 150 that is generated from the RAW image frame 140 of FIG. 1B. Note the scene 120 from the RAW image frame 140 has been enhanced such that the object 130 is visible in the enhanced image frame 150. An enhanced image frame renders the imaged portion of the scene 120 in a low noise manner that is brighter than the corresponding RAW image frame 140. Enhanced image frame(s) may render objects subject to low light conditions in a manner that allows for detection within a target range (e.g., 600 yards). Enhanced video output from the digital night vision device 110 is composed of a plurality of enhanced image frames.

Note poorly lit scenes can be difficult to effectively image with conventional digital cameras (e.g., on smart phones), in particular, for real-time video applications, as for conventional digital cameras it generally takes long exposures and/or many image frames that are combined in post processing to generate a single enhanced frame, both of which are too slow (on the order of seconds) for real-time video applications. In contrast, the digital night vision device 110 is able to generate enhanced frames in real-time (e.g., at a frame rate of 90 Hz or more) such that it can output enhanced video of the scene 120.

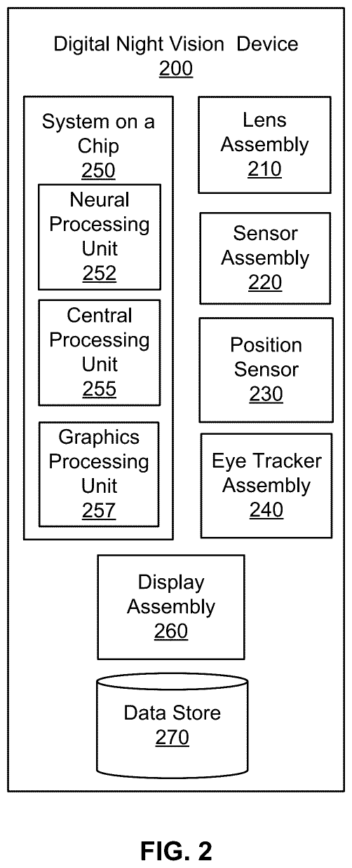

FIG. 2 is a block diagram of a digital night vision device 200, in accordance with one or more embodiments. The digital night vision device 200 described above with regard to FIG. 1A may be an embodiment of the digital night vision device 200. In some embodiments, the digital night vision device 200 may be incorporated into a head-mounted night vision system. In the embodiment of FIG. 2, the digital night vision device 200 includes a lens assembly 210, a sensor assembly 220, a position sensor 230, an eye tracker assembly 240, a system on a chip (SoC) 250, a display assembly 260, and a data store 270. Alternative embodiments may include more, fewer, or different components from those illustrated in FIG. 2, and the functionality of each component may be divided between the components differently from the description below. For example, in some embodiments, digital night vision device 200 may not include the position sensor 230, the eye tracker assembly 240, or some combination thereof. Additionally, each component may perform their respective functionalities in response to a request from a human, or automatically without human intervention.

The lens assembly 210 captures light from a scene (e.g., low light scene) and directs it toward the sensor assembly 220 via one or more optical channels. The lens assembly 210 includes one or more optical elements (e.g., lenses, prisms, mirrors, etc.) that can be arranged to form the one or more optical channels. For example, the one or more optical elements may be arranged for monocular (single optical channel) video captures. In another example, there are a plurality of optical elements that are arranged for binocular (two optical channels) video capture. In some embodiments, optical element(s) of the one or more optical channels may be selected to provide a wide angle field of view (e.g., 45 degrees or more).

The sensor assembly 220 is configured to capture RAW video of the scene. The sensor assembly 220 includes one or more sensors. The sensors may be low-light sensors. A low-light sensor is a digital sensor (e.g., complementary metal-oxide-semiconductor (CMOS)) that has been optimized for low light conditions. In some embodiments, the low-light sensor has a high-pixel pitch, utilizing binning, uses some other mechanism for improved low light sensitivity, or some combination thereof. In some embodiments, there is a low-light sensor for each of the one or more optical channels. In some embodiments, a single low-light sensor may receive light from different optical channels. In some embodiments, the low-light sensor has a rolling shutter (enables concurrent frame readout as the frame is being captured).

The position sensor 230 generates positional data in response to motion of the digital night vision device 200. The position sensor 230 may include an inertial measurement unit (IMU). Examples of position sensor 230 include: one or more accelerometers, one or more magnetometers, one or more gyroscopes, another suitable type of sensor that detects motion, or some combination thereof. The position sensor 230 may be located external to the IMU, internal to the IMU, or some combination thereof.

The digital night vision device 200 may include the eye tracker assembly 240 that determines eye tracking information. The eye tracking information may comprise information about a position and an orientation of one or both eyes (within their respective eye-boxes), gaze location, etc. The eye tracker assembly 240 may include one or more cameras. In some embodiments, the eye tracker assembly 240 estimates an angular orientation of one or both eyes based on images captures of one or both eyes by the one or more cameras. In some embodiments, the eye tracker assembly 240 may also include one or more illuminators that illuminate one or both eyes with an illumination pattern (e.g., structured light, glints, etc.). The eye tracker assembly 240 may use the illumination pattern in the captured images to determine the eye tracking information.

The SoC 250 controls the digital night vision device 200. The SoC 250 includes a neural processing unit (NPU) 252, a central processing unit (CPU) 255, and a graphics processing unit (GPU) 257. In alternate embodiments, the SoC 250 may include more, fewer, or different components from those illustrated in FIG. 2. For example, in some embodiments, the SoC 250 may not include the GPU 257. Or in some cases, the SoC 250 may include an ISP, however, in those cases the ISP does not process RAW video data, and instead just provides the RAW video data to the NPU 252.

The NPU 252 generates enhanced video data from RAW video data from the sensor assembly 220. The RAW video data includes a plurality of RAW image frames. For a given time t, the NPU 252 encodes a RAW image frame t. The NPU 252 aligns the encoded version of the RAW image frame t with an encoded version of an immediately prior RAW image frame t−1 to form an aligned encoded image frame. In some embodiments, the NPU 252 uses positional information from the position sensor 230 and/or optical flow techniques to align the encoded version of the RAW image frame t with the encoded version of the immediately prior RAW image frame t−1.

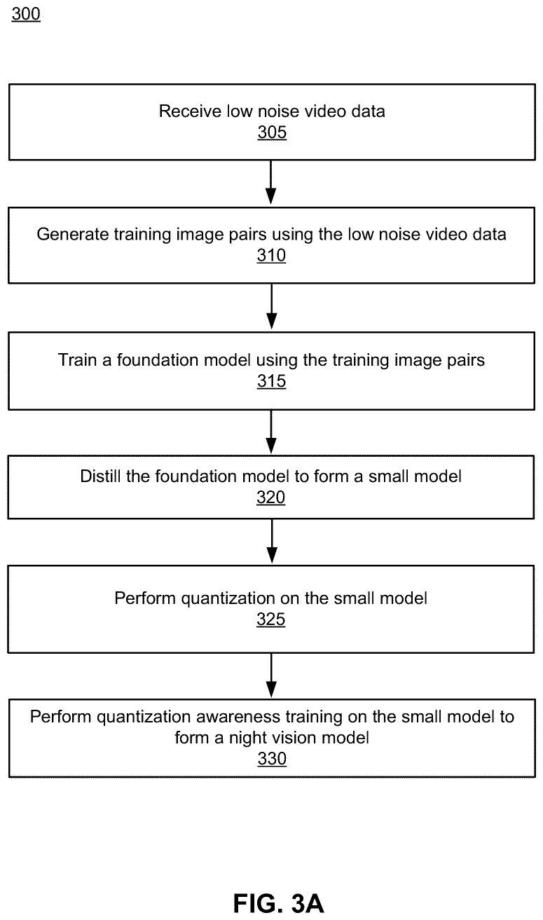

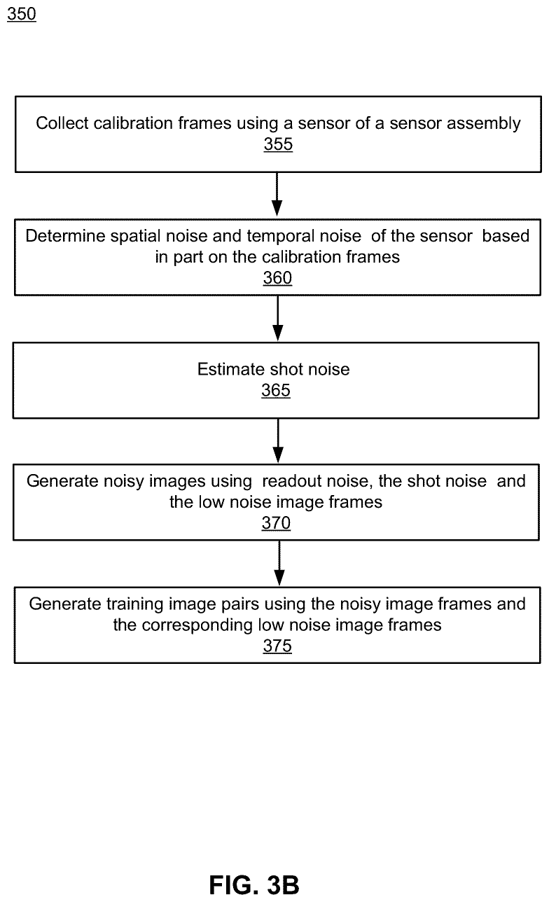

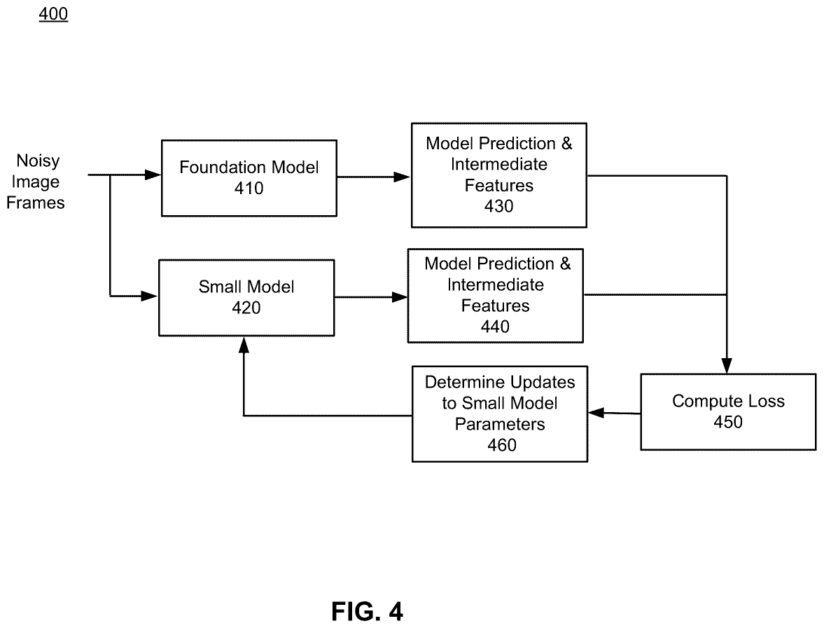

The NPU 252 generates enhanced image frames using a night vision model, aligned encoded frames, and a latent frame history. The night vision model is a recurrent neural network that operates on the NPU 252. For example, the night vision model may have a recurrent U-Net architecture. Example methods used in the formation of the night vision model are described below with regard to FIGS. 3A, 3B, and 4. The latent frame history includes a most recent latent frame output by the night vision model. A latent frame includes embedded features that are used by the night vision model in the generation of enhanced image frames. For example, a latent frame may be an embedding which allows the night vision model to encode features across a dimension (e.g., time). Continuing with the example above, the NPU 252 applies at least a portion of the aligned encoded image frame and the latent frame history to the night vision model to generate an enhanced image frame and an updated latent frame history. The updated latent frame history may then be fed back into the night vision model as part of the generation of the next enhanced image frame. In this manner, the digital night model outputs a plurality of enhanced image frames that correspond to the RAW image frames of the RAW video data.

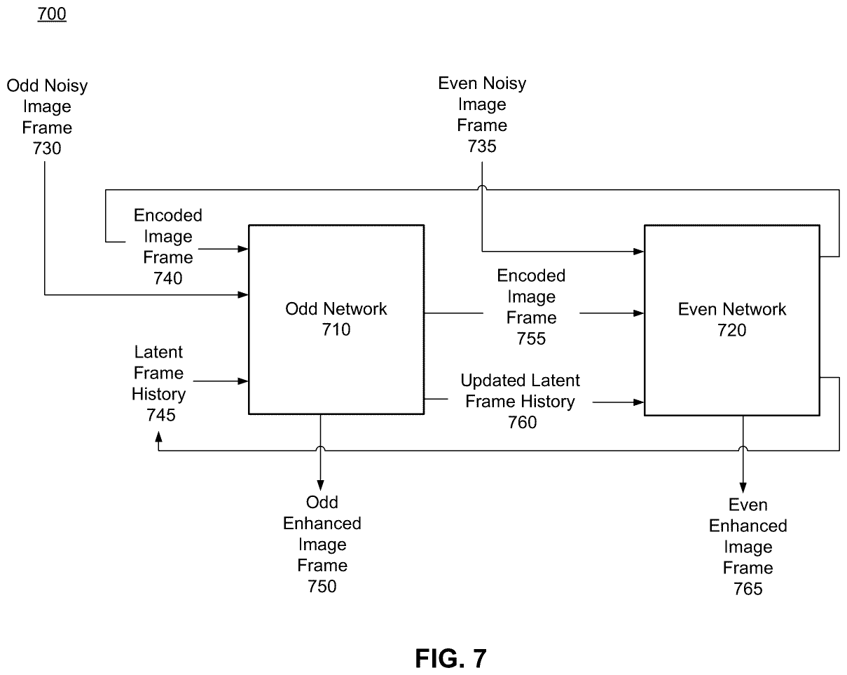

In some embodiments, the night vision model may be composed of a plurality of specialized networks (e.g., an even network and an odd network) that process different parts of the captured RAW video data. An example is shown and described below with regard to FIG. 7.

In some embodiments (e.g., binocular case), the night vision model may process enhanced frames from multiple channels. For example, the RAW video may include a data stream of RAW image frames from a first channel (e.g., corresponds to the left eye), and another data stream of RAW image frames from a second channel (e.g., corresponds to right eye). In these embodiments, the NPU 252 may generate an aligned encoded image frame for each of the channels. The NPU 252 may apply at least a portion of the generated aligned encoded image frames from each channel and the latent frame history(ies) to the night vision model to generate enhanced image frames for each channel. In some embodiments, to generate an enhanced image frame for the first channel, the night vision model may use the aligned encoded image frame for the first channel as well as the aligned encoded image frame for the second channel. Likewise, to generate an enhanced image frame for the second channel, the night vision model may use the aligned encoded image frame for the second channel as well as the aligned encoded image frame for the first channel.

In some embodiments, the NPU 252 may generate enhanced images with a variable spatial resolution (e.g., for foveated rendering). For example, the NPU 252 may adjust a spatial resolution of aligned encoded image frames based in part on the eye tracking information to have variable spatial resolution. An image frame with variable spatial resolution has a first resolution for a first region of the image frame that is higher than a second resolution of a peripheral region that is outside the first region. The location of the first region in the image frame is based in part on a gaze location (e.g., part of the eye tracking information) of the user. In some embodiments, there is a variable change in resolution that drops, in part, as a function of distance from the first region. A size of the first region may be based on, e.g., a foveal region of a human eye. The NPU 252 may apply the aligned encoded image frame(s) with the variable spatial resolution and the latent frame histor(ies) to the night vision model to generate enhanced image frames of the scene that have variable spatial resolution.

In another embodiment, instead of adjusting the spatial resolution of the aligned encoded image frames input to the night vision model, the night vision model is configured to generate enhanced image frames of the scene that have variable spatial resolution based in part on the eye tracking information. For example, the NPU 252 may apply an aligned encoded image frame, the eye tracking information, and the latent frame history to the night vision model to generate an enhanced image frame of the scene that has variable spatial resolution.

For simplicity, the above discussion is largely in the context of processing entire image frames. However, in other embodiments, the NPU 252 may be modified to perform partial frame processing (e.g., ½ frame, ¼ frame, row-by-row, etc.). This may speed up photon-to-photon latency of the digital night vision device 200, thereby, allowing for operation at faster frame rates (relative to full frame processing). For example, the NPU 252 may generate a portion of an enhanced image frame given a portion of a corresponding RAW image frame that was readout from a sensor of the sensor assembly 220. And as additional portion(s) of the corresponding RAW image frame are readout, the NPU 252 continues to process those portions to generate corresponding portion(s) of the enhanced image frame until the entire enhanced image frame is formed. In contrast, in embodiments using full frame processing, the entire RAW image frame is readout prior to being able to process it with the NPU 252 to form a corresponding enhanced image frame.

The CPU 255 controls the operation of the digital night vision device 200. The CPU 255 may direct the enhanced image frames output from the night vision model to other components of the digital night vision device 200. For example, the CPU 255 may direct the enhanced image frames to the GPU 257, the display assembly 260, etc. In some embodiments, the CPU 255 may perform some or all of the functions of the GPU 257, and in some embodiments, there is no GPU 257.

The GPU 257 may render enhanced video data that is based in part on the plurality of enhanced image frames. In some embodiments, the GPU 257 may augment some or all of the plurality of enhanced image frames with visual information (e.g., virtual overlays, markers, etc.) as part of rendering the enhanced video data.

The GPU 257 and/or CPU 255 may perform real-time perspective correction of the enhanced image frames. The distortion may be caused by, e.g., wide angle lenses in the lens assembly 210 and/or display optics in the display assembly 260. The real-time perspective projection may be implemented in a manner (e.g., HALIDE) that makes use of parallelization and vectorization in order to facilitate real-time perspective correction. The real time perspective correction may run on the GPU 257 and/or the CPU 255 of the SoC 250 in a separate thread from the main process. Since the real time perspective correction runs on the GPU 257 and/or the CPU 255, the night vision model running on the NPU 252, is able to start processing the next aligned encoded frame and latent frame history while the real time perspective correction is processing the most recent enhanced image frame output from the night vision model.

The display assembly 260 includes one or more displays that are configured to present the enhanced video of the scene. In some embodiments, there is a single display. In some embodiments, there is a display for each eye of a user. The one or more displays may be monochrome, color, or some combination thereof. Examples of a display include: a liquid crystal display (LCD), an organic light emitting diode (OLED) display, an active-matrix organic light-emitting diode display (AMOLED), a waveguide display, some other display, or some combination thereof. The display assembly 260 may include display optics to direct enhanced video data to one or more eyeboxes. An eyebox is a location in space that an eye of a user of the digital night vision device 200 occupy while they use the device. In some embodiments, the display optics may magnify enhanced video presented by the one or more displays. In some embodiments, the display optics may correct optical errors associated with the enhanced video presented by the one or more displays. Note in some embodiments, instead of the one or more displays the display assembly 260 includes an interface that can provide the enhanced video data to one or more displays that are separate from the digital night vision device 200.

The data store 270 stores data used by the digital night vision device 200. For example, the data store 270 may store RAW image frames and/or portions thereof, encoded RAW image frames and/or portions thereof, enhanced image frames and/or portions thereof, RAW video data, enhanced video data, latent frame history, calibration data (e.g., calibration frames), etc. The data store 270 also stores a trained night vision model. For example, the data store 270 may store the set of parameters for the night vision model on one or more non-transitory, computer-readable media.

Note that a latency between capturing the RAW video and presenting the enhanced video can be quite low (e.g., below 10 milliseconds). In this manner, the digital night vision device 200 is able to provide enhanced video data in real-time and frame rates of 90 Hz and above. Moreover, the night vision model can function as a more powerful ISP than what is found in conventional night vision devices. And while the night vision model can generally denoise collected image frames to generate enhanced video data, in some embodiments the night vision model may also handle, e.g., tone mapping, white balancing (e.g., for color images), etc., in the production of the enhanced video data. In some embodiments, the night vision model may also be tuned such that the enhanced video data looks more “daylike” or brighten it in a different way after denoising.

FIG. 3A is a flowchart 300 for a method of forming a night vision model, in accordance with some embodiments. The night vision model may be, e.g., the night vision model of the digital night vision device 200. Alternative embodiments may include more, fewer, or different steps from those illustrated in FIG. 3A, and the steps may be performed in a different order from that illustrated in FIG. 3A. These steps may be performed by a training system (e.g., a computer system that includes a processor and a non-transitory computer-readable medium). Additionally, each of these steps may be performed automatically by the training system without human intervention.

The training system receives 305 low noise video data. The low noise video data may be collected using a camera configured to capture video data of a well-lit scene. The collected video data may be in a RAW format. Low noise video data is composed of low noise image frames. A low noise image frame is well exposed (e.g., exposure is not clipped) and captured in a well-lit environment (e.g., daylight). For example, a low noise image frame may be an image frame that is properly metered, properly illuminated, in focus, and has a low ISO. As such the collected low noise video data can function as ground truth data. In some embodiments, the low noise video data may be collected using a digital night vision device (e.g., the digital night vision device 200). In other embodiments, it may be collected by some other camera.

The training system generates 310 training image pairs using the low noise video data. This is described in detail below with regard to FIG. 3B. A training pair includes a low noise image frame of a scene and a corresponding noisy image frame (simulating the scene in a low light condition) generated from the low noise image frame. In this manner, each noisy image frame has a corresponding low noise image frame that acts as ground truth.

The training system trains 315 a foundation model using the training image pairs. The training system applies the noisy image frames from the training image pairs to the foundation model to generate corresponding enhanced image frames. Note that the foundation model is a large model that does not run in real-time. The training system may perform one or more loss computations (e.g., Charbonnier loss, structural similarity index (SSIM), learned perceptual image patch similarity (LPIPS), adversarial losses, etc.) that compare the enhanced image frames to the corresponding low noise image frames (i.e., ground truth). From the loss computation(s), a gradient descent algorithm (e.g., adaptative movement estimation algorithm (ADAM)) may be used to find an updated set of parameters for the foundation model. The training system updates the parameters of the foundation model using the updated set. Step 310 may be repeated multiple times to train the foundation model, and in some embodiments, the training may include repeating step 305 multiple times as well.

The training system distills 320 the foundation model to form a small model. The training system performs a knowledge distillation process to transfer the knowledge from the trained large foundation model to the small model. This process is described in detail below with regard to FIG. 4. The distillation facilitates transfer of knowledge from the large, computationally expensive foundation model to a small model that has much less power and memory consumption without losing validity.

Note that in some embodiments, the training system may have to select an architecture for the small model to use prior to distillation. For example, to find a best Recurrent U-Net architecture that runs under a target latency on a SoC of the digital night vision device, the training system may search over many permutations of the recurrent U-Net format. A recurrent U-Net can be permuted in several ways—the downsampling method can be, for example, average pooling, maximum pooling, or strided convolution. The upsampling method can be, for example, nearest neighbor upsampling, bilinear upsampling, or transposed convolution. The depth of the U-Net and number of convolutional filters of each block can be permuted. The training system may generate a permutation of the recurrent U-Net. The training system may quantize this network and run the network on the SoC for many iterations to determine its average runtime. If the runtime is below a target threshold, the training system discards it. If it is not discarded, the training system may train the network on an arbitrary computer vision task, such as denoising, for a small amount of time, to get a rough benchmark of its performance as a neural network. The training system may select the network with the best performance on the arbitrary computer vision task for the small model.

The training system performs 325 quantization on the small model. The training system, e.g., converts floating-point numbers used by the small model to lower precision formats. For example, the training system may convert 32-bit floating-point numbers into lower precision formats, such as 8-bit integers. This reduction in precision helps the small model run faster during inference, consume less power, and occupy less memory.

The training system performs 330 quantization aware training on the small model to form the night vision model. The training system may, e.g., fine tune the small model with quantization aware training, where the fine-tuned model is referred to as the night vision model.

Note that distilling the knowledge from the large foundation model to the small model, and then further quantizing and performing quantization aware training forms a night vision model that consumes low power, occupies less memory, runs quickly at inference, and maintains performance. In this manner, the night vision model can be executed in a digital night vision device that has form factor and/or low power constraints (e.g., as part of a head mounted night vision system).

FIG. 3B is a flowchart 350 for a method of generating training image pairs using low noise video data, in accordance with some embodiments. The flowchart 350 corresponds to the step 310 of FIG. 3A. Alternative embodiments may include more, fewer, or different steps from those illustrated in FIG. 3B, and the steps may be performed in a different order from that illustrated in FIG. 3B. These steps may be performed by the training system described above with regard to FIG. 3A. Additionally, each of these steps may be performed automatically by the training system without human intervention.

The training system collects 355 calibration frames using a sensor. The sensor is a sensor of the sensor assembly 220 of digital night vision device 200. The calibration frames may include, e.g., dark frames, flat frames (e.g., taken to eliminate vignetting/light falloff and other artifacts in the image due to dust, dirt, or smudges on the sensor or optical elements), photo-response non-uniformity data, etc. Dark frames are frames where no sensor assembly 220 collects image frames while shielded from light (i.e., no light is incident on sensor(s) of the sensor assembly).

The training system determines 360 spatial noise and temporal noise of the sensor based in part on the calibration frames. For example, the training system may determine readout noise (may also be referred to as read noise) based in part on the calibration frames. Readout noise of the sensor is the equivalent noise level at the output of the sensor in the dark and at zero integration time. Note in embodiments where the sensor is a CMOS sensor, each pixel may have a slightly different readout noise value. In some embodiments, the training system applies fixed pattern noise correction to the dark frames to remove temporally consistent noise. The training system may then randomly sample patches from this dataset and use those to represent the read noise. In some embodiments, the training system determines a distribution of the readout noise and determines the readout noise for a dark frame to be the mean of the distribution. In some embodiments, the training system may average the means of the distributions generated from each dark frame to determine the readout noise. Note that the readout noise is based on real data (e.g., the dark frames) from the sensor. In contrast, conventional night vision cameras typically do not use real data to determine readout noise, but instead simply generate synthetic readout noise. But using synthetic readout noise can be problematic as, e.g., low light CMOS sensors can exhibit other forms of noise (e.g., speckle noise) that are not accurately described by synthetic readout noise.

The training system estimates 365 shot noise. Shot noise is caused by the arrival process of light photons on the sensor. The training system may estimate the shot noise using Photon Transfer Curve (PTC) modeling and/or one or more conventional techniques (e.g., model with a Poisson distribution).

The training system generates 370 noisy image frames using the readout noise, the shot noise and the low noise image frames. The training system selects a target lighting condition for each of the low noise image frames. In some embodiments, at least some of the target lighting conditions are different for different frames, which can be useful in ensuring the night vision model is robust for different lighting conditions. The training system may use a low light adjustment (LLA) model to generate the noisy image frames. Responsive to a target lighting condition and an image frame being applied to the LLA model, the LLA model outputs a noisy image frame that is the image frame adjusted to have a noise level and brightness level associated with the target lighting condition. The training system updates the LLA model with the shot noise and the readout noise. For a low noise image frame, the training system applies the low noise image frame and a target lighting condition for the low noise image frame to the LLA model. The LLA model may apply the readout noise and photo response non-uniformity to the low noise image frame, and then apply the shot noise (e.g., on a per pixel basis) to form a pseudo noisy image frame. The LLA then adjusts an exposure of the pseudo noisy image frame in accordance with the target lighting condition to form a noisy image frame. In this manner, the LLA model may output a noisy image frame that has a level of noise that corresponds to the target lighting condition. The training system performs this process for some or all of the low noise image frames to generate the noisy image frames.

The training system generates 375 training image pairs using the noisy image frames and the corresponding low noise image frames. Training system associates the low noise image frames with their corresponding noisy images to form the training image pairs.

FIG. 4 is a block diagram 400 of a process for distilling a foundation model to form a small model, in accordance with some embodiments. The process corresponds to portions of the step 320 of FIG. 3A. Alternative embodiments may include more, fewer, or different steps from those illustrated in FIG. 4, and the steps may be performed in a different order from that illustrated in FIG. 4. These steps may be performed by the training system of FIGS. 3A and 3B. Additionally, each of these steps may be performed automatically by the training system without human intervention.

The training system inputs noisy image frames into a foundation model 410 and a small model 420. The foundation model 410 and the small model 420 are embodiments of the foundation model and small model described above with reference to FIG. 3A. Responsive to the input, the foundation model 410 predicts 430 a first set of enhanced image frames and intermediate features that correspond to the noisy image frames, and the small model 420 predicts 440 a second set of enhanced image frames and set of intermediate features that correspond to the noisy image frames.

The training system computes 450 loss using the first set and the second set. The training system computes a difference between the first set and the second set. For example, for a single noisy image frame, in the first set there is a corresponding first enhanced image frame and a first intermediate features frame, and in the second set there is a corresponding second enhanced image frame and second intermediate features frame. The training system may take a difference of the first enhanced image frame and the second enhanced image frame to form a difference image frame and take a difference of the first intermediate features frame and the second intermediate features frame to form a difference intermediate frame. The training system performs this process for each of the applied input noisy images in order to generate a corresponding difference frame and a corresponding intermediate features frame.

The training system determines 460 updates to the small model parameters. For example, the training system may use a gradient descent algorithm (e.g., such as ADAM) and the differences frames and the intermediate feature frames to find an updated set of parameters for the small model 420. The training system may update the parameters of the small model 420 with the determined updates.

Some or all of the process may be repeated. And once the computed loss(es) are below a threshold amount, the distillation of knowledge from the foundation model 410 to the small model 420 is complete. This is helpful in that the small model is much less computationally expensive than the foundation model, can be run on less powerful hardware, etc. This in combination with quantization (and quantization aware training) to form the night vision model, helps facilitate the night vision model being able to be executed locally on a digital night vision device having low power requirements and form factor constraints while still maintaining high levels of performance.

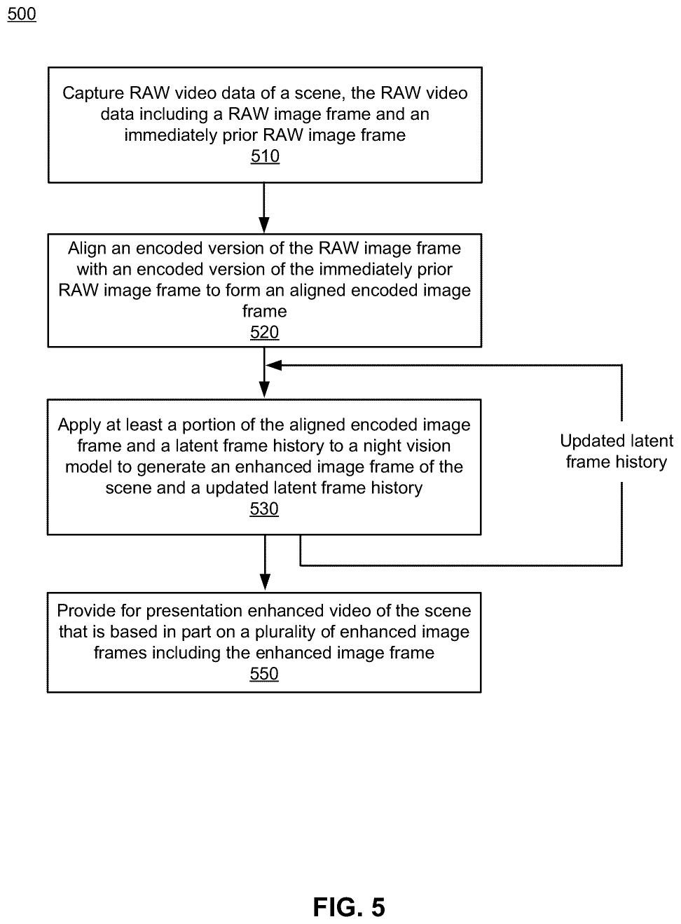

FIG. 5 is a flowchart 500 for a method of using a digital night vision device to generate enhanced video data of a scene, in accordance with some embodiments. Alternative embodiments may include more, fewer, or different steps from those illustrated in FIG. 5, and the steps may be performed in a different order from that illustrated in FIG. 5. These steps may be performed by the digital night vision device 200. Additionally, each of these steps may be performed automatically by the digital night vision device without human intervention.

The digital night vision device captures 510 RAW video data of a scene. The RAW video data includes a RAW image frame and an immediately prior RAW image frame. The scene may be a low light scene.

The digital night vision device aligns 520 an encoded version of the RAW image frame with an encoded version of the immediately prior RAW image frame to form an aligned encoded image frame. The digital night vision device encodes the RAW image frame and the immediately prior RAW image frame (which was encoded prior to the RAW image frame). A NPU (e.g., the NPU 252) of the digital night vision device may align the encoded version of the RAW image frame with the encoded version of the immediately prior RAW image frame using based in part on, e.g., positional information (e.g., from the position sensor 230) and/or using optical flow techniques.

The digital night vision device applies 530 at least a portion of the aligned encoded image frame and a latent frame history to a night vision model to generate an enhanced image of the scene and an updated latent frame history. The latent frame history may have been output from the night vision model as part of the generation of a previous enhanced image frame. The NPU may apply some or all of the aligned encoded image frame and the latent frame history to the night vision model. The night vision model outputs the enhanced image of the scene and the updated latent frame history. The updated latent frame history may be used by the night vision model in the generation of a next enhanced image frame.

In some embodiments, the entire aligned encoded image frame is used by the night vision model to generate the enhanced image. In some embodiments, the NPU may adjust the aligned encoded image frame to have variable spatial resolution using eye tracking information from an eye tracker assembly (e.g., the eye tracker assembly 240) of the digital night vision device. The NPU may apply the adjusted aligned encoded image frame to the night vision model with the latent frame history to generate an enhanced image frame having variable spatial resolution. In another embodiment, the NPU may in addition to the aligned encoded image frame and the latent frame history, also apply eye tracking information from the eye tracker assembly to the night vision model. And the night vision model outputs an enhanced image frame having variable spatial resolution and an updated latent frame history.

The digital night vision device provides 550, for presentation, enhanced video of the scene that is based in part on a plurality of enhanced image frames including the enhanced image frame. In some embodiments, the digital night vision device provides the enhanced video to a display that is separate from the digital night vision device. In some embodiments, the digital night vision device includes a display assembly that includes one or more displays that present the enhanced video. For example, the digital night vision device may be integrated into a head-mounted night vision system and the one or more displays are configured to provide the enhanced video to one or more eyeboxes. In some embodiments, the digital night vision device may correct one or more optical errors in the enhanced video prior to its presentation. For example, a processor (e.g., CPU and/or GPU) of the digital night vision device may correct for distortion caused by e.g., wide angle lenses in a lens assembly of the night vision device and/or display optics in the display assembly. In some embodiments, the display optics may also be configured to correct for various optical errors.

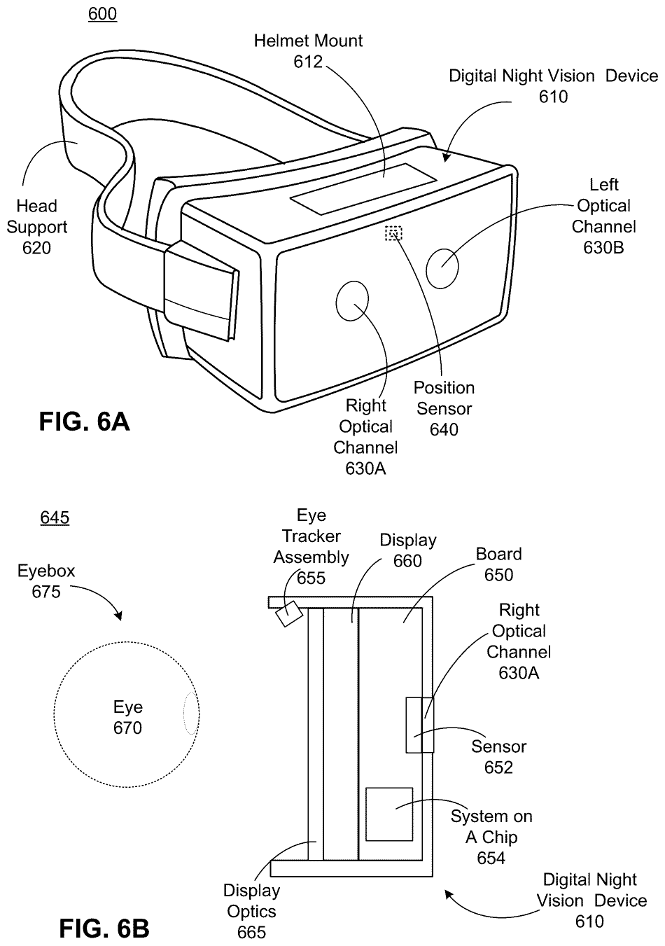

FIG. 6A is a perspective view of an example head-mounted night vision system 600, in accordance with one or more embodiments. The head-mounted night vision system includes a digital night vision device 610, and in some embodiments may also include a head support 620. The digital night vision device 610 is an embodiment of the digital night vision device 200. The digital night vision device 610 is an example of a multichannel embodiment where a lens assembly of the digital night vision device 610 that includes a right optical channel 630A and a left optical channel 630B. The digital night vision device 610 also includes a position sensor 640. The position sensor 640 is an embodiment of the position sensor 230, other components of the digital night vision device 610 are shown and described below with regard to FIG. 6B. The head support 620 may be, e.g., an elastic band or some other type of harness that can securely position the digital night vision device 610 on a head of a user. In some embodiments, the digital night vision device 610 includes a helmet mount 612, and may or may not include the head support 620. The helmet mount 612 is a mechanism that facilitates coupling the digital night vision device 610 to a helmet.

While FIG. 6A illustrates the components of the head-mounted night vision system 600 in example locations, in some embodiments the components may be located elsewhere on the head-mounted night vision system 600. Similarly, there may be more or fewer components on the head-mounted night vision system 600 than what is shown in FIG. 6A. Moreover, in some embodiments, a form factor of the head-mounted night vision system 600 may differ from what is illustrated. For example, in some embodiments, the head-mounted night vision system 600 may have a form factor of a pair of eyeglasses, be integrated into a helmet, etc.

FIG. 6B is a cross sectional view 645 of the digital night vision device 610 of FIG. 6A. The digital night vision device 610 includes a board 650, an eye tracker assembly 655, a display 660, and display optics 665. The board 650 provides structure and a mounting surface to some components of the digital night vision device 610. For example, the board 650 may include a sensor assembly that includes a sensor 652. The sensor 652 captures light from the right optical channel 630A as RAW image frames. The board 650 may also include a SoC 654. The SoC 654 is substantially the same as the SoC 250, and generates enhanced video data using the RAW image frames.

The eye tracker assembly 655 is an embodiment of the eye tracker assembly 240. The eye tracker assembly 655 generates eye tracking information based on a position and orientation of an eye 670 in an eyebox 675 of the digital night vision device 610. The SoC 654 may use the eye tracking information to generate enhanced video data having variable spatial resolution to, e.g., facilitate foveal rendering.

The display 660 may present enhanced video data that is based in part on enhanced image frames output from the SoC 654. The display optics 665 direct the enhanced video data to the eyebox 675. In some embodiments, the display optics 665 may also correct one or more optical errors (e.g., due to a wide angle lens(es) in the right optical channel 630A) in the enhanced video data.

While FIG. 6B illustrates the components of the digital night vision device 610 in example locations, in some embodiments the components may be located elsewhere on the digital night vision device 610. Similarly, there may be more or fewer components on the digital night vision device 610 than what is shown in FIG. 6B. Moreover, in some embodiments, the form factor of the digital night vision device 610 may differ.

FIG. 7 is a block diagram 700 of a process of operation of a night vision model having multiple networks, in accordance with some embodiments. The night vision model includes an odd network 710 and an even network 720. The odd network 710 is configured to process odd numbered image frames to generate corresponding odd enhanced image frames, and the even network 720 is configured to process even numbered image frames to generate corresponding even enhanced image frames. The odd network 710 may be independent from the event network 720. The odd network 710 and the even network 72 may be different or similar, may have similar sizes or different sizes, etc. The odd and even enhanced image frames may be interleaved to form enhanced video data. The night vision model is an embodiment of the night vision model described above with regard to FIGS. 1-5. Alternative embodiments may include more, fewer, or different steps from those illustrated in FIG. 7, and the steps may be performed in a different order from that illustrated in FIG. 7.

The night vision model receives RAW video data of a scene. The raw video data is composed of noisy image frames with even numbered noisy image frames interleaved with odd numbered noisy image frames. In the illustrated example, the noisy image frames include an odd noisy image frame 730, followed by an even noisy image frame 735. For example, if ‘i” is an index that numbers image frames of the raw video data, the odd noisy image frame 730 may correspond to i, and the even noisy image frame may correspond to i+1.

The odd noisy image frame 730, an encoded image frame 740, and a latent frame history 745 are applied to the odd network 710. The encoded image frame 740 is an encoded version of an even noisy image frame (e.g., i−1) that occurred immediately before the odd noisy image frame 730, and was encoded by the even network 720. The latent frame history 745 is a most recent latent frame history output from the even network 720 (e.g., output as part of the processing of the i−1 even noisy image frame). In response, the odd network 710 outputs an odd enhanced image frame 750, an encoded image frame 755, and an updated latent frame history 760. The odd enhanced image frame 750 corresponds to the odd noisy image frame 730. The encoded image frame 755 is an encoded version of the odd noisy image frame 730. For example, the odd noisy image frame 730 may be a 1×Height×Width image buffer. The odd network 710 encodes the odd noisy image frame 730 to generate the encoded image frame 755. The encoded image frame 755 may be, e.g., a C×H×W “image” buffer where C is an integer number of channels that represent features and H and W represent, respectively, a height and width of the encoded image frame 755. Note that in some instances H and/or W may differ from the height and/or width of the odd noisy image frame 730. A similar process is used by the even network 720 to encode even noisy image frames.

The even noisy image frame 735, the encoded image frame 755, and the updated latent frame history 760 are applied to the even network 720. In response, the even network 720 outputs an even enhanced image frame 765, an encoded image frame corresponding to the even noisy image frame 740, and an updated latent frame history. The even enhanced image frame 765 corresponds to the even noisy image frame 735. The encoded image frame and the updated latent frame history may be input into the odd network 710 to process a subsequent odd noisy image frame (i.e., i+2).

In some embodiments, odd noisy image frames are aligned (e.g., using optical flow techniques and/or IMU data) with encoded image frames prior to being applied to the odd network 710. Similarly, in some embodiments, even noisy image frames are aligned (e.g., using optical flow techniques and/or IMU data) with encoded image frames prior to being applied to the even network 720.

The night vision model may interleave odd and even enhanced image frames to form enhanced video data. The odd network 710 and the even network 720 may be experts at their own subsets thereby improving overall performance. For example, as the odd network 710 and the even network 720 can specialize they can be smaller and faster than a single large network.

### Additional Configuration Information

The described embodiments include various technical improvements in a field of digital night vision device that uses artificial intelligence based image signal processing. A digital night vision device and processing method generates night vision imagery at least on par with analog night vision. The digital night vision device uses a night vision model (i.e., a recurrent neural network) to generate enhanced video data and can be run at very high frame rates (e.g., 90+ Hz) to deliver a comfortably viewable image feed. Moreover, the digital night vision device is able to do this subject to form factor constraints of a low power head-mounted device. Additionally, the digital night vision device may further utilize wide-angle lens(es) and provide real-time distortion correction.

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A head-mounted night vision system comprising:
a sensor assembly configured to capture RAW video data of a scene, the RAW video data including a RAW image frame and an immediately prior RAW image frame;
a neural processing unit configured to:
align an encoded version of the RAW image frame with an encoded version of the immediately prior RAW image frame to form an aligned encoded image frame, and
apply at least a portion of the aligned encoded image frame and a latent frame history to a night vision model to generate an enhanced image frame of the scene; and
a display assembly that includes a display configured to present enhanced video data of the scene based that is based in part on a plurality of enhanced image frames including the enhanced image frame.

2. The head-mounted night vision system of claim 1, wherein the night vision model is a recurrent neural network.

3. The head-mounted night vision system of claim 1, wherein the RAW Video data includes a first data stream of RAW image frames from a first channel and a second data stream of RAW image frames from a second channel, and the first data stream includes the RAW image frame and the immediately prior RAW image frame, and the second data stream includes a second RAW image frame and a second immediately prior RAW image frame, and the neural processing unit is further configured to:
align a second encoded version of the second RAW image frame with an encoded version of the second immediately prior RAW image frame to form a second aligned encoded image frame; and
apply at least a portion of the aligned encoded image frame, at least a portion of the second aligned encoded image frame and the latent frame history to the night vision model to generate the enhanced image frame of the scene and a second enhanced image frame of the scene, wherein the night vision model uses both the aligned encoded image frame and the second aligned encoded image frame in the generation of the enhanced image frame and the generation of the second enhanced image frame,
wherein the display assembly further comprises:
a second display configured to present a second enhanced video data of the scene that is based in part on a second plurality of enhanced image frames including the second enhanced image frame, and the first display is configured to provide the enhanced video data to a left eyebox of the head-mounted night vision system and the second display is configured to provide the second enhanced video data to a right eyebox of the head-mounted night vision system.

4. The head-mounted night vision system of claim 1, further comprising:
an inertial measurement data configured to provide positional data of the head-mounted night vision system,
wherein the neural processing unit is configured to use the positional data to align the encoded version of the RAW image frame with the encoded version of the immediately prior RAW image frame.

5. The head-mounted night vision system of claim 1, further comprising:
an eye tracker assembly configured to determine eye tracking information of an eye within an eyebox of the head-mounted night vision system;
wherein the neural processing unit is configured to:
adjust a spatial resolution of the aligned encoded image frame based in part on the eye tracking information to have variable spatial resolution, wherein an image frame with variable spatial resolution has a first resolution for a first region of the image frame that is higher than a second resolution of a peripheral region that is outside the first region, wherein a location of the first region corresponds to a gaze location of the eye, and
apply the aligned encoded image frame with the variable spatial resolution and the latent frame history to the night vision model to generate the enhanced image frame of the scene, wherein the enhanced image frame of the scene has variable spatial resolution.

6. The head-mounted night vision system of claim 1, further comprising:
an eye tracker assembly configured to determine eye tracking information of an eye within an eyebox of the head-mounted night vision system;
wherein the neural processing unit is configured to:
apply the aligned encoded image frame, the eye tracking information, and the latent frame history to the night vision model to generate the enhanced image frame of the scene, wherein the enhanced image frame of the scene has variable spatial resolution such that the enhanced image frame has a first resolution for a first region of the enhanced image frame that is higher than a second resolution of a peripheral region that is outside the first region, wherein a location of the first region corresponds to a gaze location of the eye.

7. The head-mounted night vision system of claim 1, wherein the neural processing unit is configured to directly receive the RAW video data from the sensor assembly.

8. The head-mounted night vision system of claim 1, wherein a latency between capturing the RAW video data and presenting the enhanced video data is below 10 milliseconds.

9. The head-mounted night vision system of claim 1, wherein the sensor assembly comprises:
a low light sensor that is configured to capture the RAW video data of the scene.

10. The head-mounted night vision system of claim 9, wherein the low light sensor that is a color sensor and the enhanced video data is in color.

11. The head-mounted night vision system of claim 1, wherein the night vision model was formed by:
generating training image pairs using low noise video data, wherein each training image pair includes a low noise image frame and a noisy image frame that was generated in part using the low noise image frame;
training a foundation model using the training image pairs;
distilling the foundation model to form a small model;
performing quantization on the small model; and
performing quantization aware training on the small model to form the night vision model.

12. A digital night vision device comprising:
a sensor assembly configured to capture RAW video data of a scene, the RAW video data including a RAW image frame and an immediately prior RAW image frame; and
a neural processing unit configured to:
align an encoded version of the RAW image frame with an encoded version of the immediately prior RAW image frame to form an aligned encoded image frame, and
apply at least a portion of the aligned encoded image frame and a latent frame history to a night vision model to generate an enhanced image frame of the scene;
wherein a display is configured to present enhanced video data of the scene based that is based in part on a plurality of enhanced image frames including the enhanced image frame.

13. The digital night vision device of claim 12, wherein the night vision model is a recurrent neural network.

14. The digital night vision device of claim 12, further comprising:
an inertial measurement data configured to provide positional data of the digital night vision device,
wherein the neural processing unit is configured to use the positional data to align the encoded version of the RAW image frame with the encoded version of the immediately prior RAW image frame.

15. The digital night vision device of claim 12, wherein the neural processing unit is configured to directly receive the RAW video data from the sensor assembly.

16. The digital night vision device of claim 12, wherein a latency between capturing the RAW video data and presenting the enhanced video data is below 10 milliseconds.

17. The digital night vision device of claim 12, wherein the sensor assembly comprises:
a low light sensor that is configured to capture the RAW video data of the scene.

18. The digital night vision device of claim 12, wherein the night vision model was formed by:
processing low noise video data to generate training image pairs, wherein each training image pair includes a low noise image frame and a noisy image frame that was generated in part using the low noise image frame;
training a foundation model using the training image pairs;
distilling the foundation model to form a small model;
performing quantization on the small model; and
performing quantization aware training on the small model to form the night vision model.

19. A method, performed at a computer system comprising a processor and a computer-readable medium, comprising:
generating training image pairs using low noise video data, wherein each training image pair includes a low noise image frame and a noisy image frame that was generated in part using the low noise image frame;
training a foundation model using the training image pairs;
distilling the foundation model to form a small model;
performing quantization on the small model; and
performing quantization aware training on the small model to form a night vision model.

20. The method of claim 19, wherein generating the training image pairs using the low noise video data, comprises:
determining readout noise of a sensor of a digital night vision device based in part on a plurality of calibration frames associated with the sensor;
estimating shot noise of the sensor;
generating noisy image frames using the readout noise, the shot noise, and low noise image frames of the low noise video data; and
generating training image pairs using the noisy image frames and the low noise image frames.
